(19) United States
(12) Patent Application Publication
(10) Pub. No.: US 2025/0377700 A1
(43) Pub. Date: Dec. 11, 2025

(54) COOLANT MIXTURE REBALANCING FOR LIQUID-COOLED SYSTEMS

(71) Applicant: INTERNATIONAL BUSINESS MACHINES CORPORATION, ARMONK, NY (US)

(72) Inventors: JOHN S. WERNER, FISHKILL, NY (US); ARKADIY O. TSFASMAN, WAPPINGERS FALLS, NY (US); JOHN TOROK, POUGHKEEPSIE, NY (US); DUSTIN DEMETRIOU, HYDE PARK, NY (US); NOAH SINGER, WHITE PLAINS, NY (US)

(21) Appl. No.: 18/736,819

(22) Filed: Jun. 7, 2024

(51) Int. Cl. G06F 1/20

(52) U.S. Cl. CPC G06F 1/20

(57) ABSTRACT

Coolant mixture rebalancing for liquid-cooled systems, including: monitoring activity of a liquid-cooled system; determining, based on the activity, that a component balance of a coolant of the liquid-cooled system should be modified; and adding, to a cooling loop of the liquid-cooled system, a component of the coolant to modify the component balance of the coolant.

### BACKGROUND

The present disclosure relates to methods, apparatus, and products for coolant mixture rebalancing for liquid-cooled systems. Liquid-cooled systems draw heat from components such as processors by transferring heat from these components to a coolant pumped through the system. Heat is then drawn from the heated coolant and dispersed so as to return the coolant to a cool state. In some of these systems, the coolant is a mixture of multiple components. When the system is initialized, the components of the coolant are present in a particular ratio or balance. This balance may change over time as the system operates. For example, one of the components may seep through hoses of the cooling loop or evaporate, thereby changing the balance of the components of the coolant. This may affect the cooling ability of the coolant, which may in turn cause performance degradation or component damage.

### SUMMARY

According to embodiments of the present disclosure, various methods, apparatus and products for coolant mixture rebalancing for liquid-cooled systems are described herein. In some aspects, coolant mixture rebalancing for liquid-cooled systems includes monitoring activity of a liquid-cooled system; determining, based on the activity, that a component balance of a coolant of the liquid-cooled system should be modified; and adding, to a cooling loop of the liquid-cooled system, a component of the coolant to modify the component balance of the coolant. In some aspects, an apparatus may include a processing device; and memory operatively coupled to the processing device, wherein the memory stores computer program instructions that, when executed, cause the processing device to perform this method. In some aspects, a computer program product comprising a computer readable storage medium may store computer program instructions that, when executed, perform this method.

### BRIEF DESCRIPTION OF THE DRAWINGS

FIG. 1 sets forth a block diagram of an example computing environment for coolant mixture rebalancing for liquid-cooled systems in accordance with some embodiments of the present disclosure.

FIG. 2 sets forth a block diagram of an example liquid-cooled system for coolant mixture rebalancing for liquid-cooled systems in accordance with some embodiments of the present disclosure.

FIG. 3 sets forth a flowchart of an example method for coolant mixture rebalancing for liquid-cooled systems in accordance with some embodiments of the present disclosure.

FIG. 4 sets forth a flowchart of another example method for coolant mixture rebalancing for liquid-cooled systems in accordance with some embodiments of the present disclosure.

FIG. 5 sets forth a flowchart of another example method for coolant mixture rebalancing for liquid-cooled systems in accordance with some embodiments of the present disclosure.

FIG. 6 sets forth a flowchart of another example method for coolant mixture rebalancing for liquid-cooled systems in accordance with some embodiments of the present disclosure.

FIG. 7 sets forth a flowchart of another example method for coolant mixture rebalancing for liquid-cooled systems in accordance with some embodiments of the present disclosure.

FIG. 8 sets forth a flowchart of another example method for coolant mixture rebalancing for liquid-cooled systems in accordance with some embodiments of the present disclosure.

FIG. 9 sets forth a flowchart of another example method for coolant mixture rebalancing for liquid-cooled systems in accordance with some embodiments of the present disclosure.

### DETAILED DESCRIPTION

In some aspects, coolant mixture rebalancing for liquid-cooled systems includes monitoring activity of a liquid-cooled system; determining, based on the activity, that a component balance of a coolant of the liquid-cooled system should be modified; and adding, to a cooling loop of the liquid-cooled system, a component of the coolant to modify the component balance of the coolant. This provides the advantage of allowing for the component balance of coolant to be adjusted over time, preventing performance degradation and component damage that may occur due to unaddressed changes in the component balance.

In some aspects, determining that the component balance should be modified may include determining that one or more performance metrics of the liquid-cooled system fails to satisfy one or more conditions. This provides the advantage of using negative changes in performance metrics to trigger a rebalancing of the component balance.

In some aspects, adding the component may include incrementally adding the component until the one or more performance metrics satisfy the one or more conditions. This provides the advantage of allowing for component rebalancing without specifically predicting the current component balance of the coolant, instead using the performance metrics to drive component rebalancing.

In some aspects, determining that the component balance should be modified may include predicting a current component balance. This provides the advantage of allowing for predicted changes in the component balance to trigger a rebalancing of the component balance.

In some aspects, predicting the current component balance is based on a configuration of the liquid-cooled system. This provides the advantage of more accurate predictions of current component balances that take into account the configuration of the liquid-cooled system.

In some aspects, determining that the component balance should be modified comprises measuring a coolant level in a mixture reservoir of the liquid-cooled system. This provides the advantage of allowing for current levels of coolant in a mixture reservoir to trigger component rebalancing.

In some aspects, this method may include determining a target component balance for the liquid cooled system, and adding the component is based on the target component balance. This provides the advantage of enabling component rebalancing to achieve a targeted component balance for the liquid-cooled system.

In some aspects, determining the target component balance is based on a configuration of the liquid-cooled system. This provides the advantage of more accurate target component balances that take into account the configuration of the liquid-cooled system.

In some aspects, determining the target component balance includes receiving data indicating the target component balance. This provides the advantage of enabling remotely determined or calculated target component balances to be received by a liquid-cooled system.

In some aspects, the data is based on a clustering of data describing a plurality of other liquid-cooled systems. This provides the advantage of more accurate target component balances based on the performance of various liquid-cooled systems and configurations.

In some aspects, an apparatus for coolant mixture rebalancing for liquid-cooled systems includes a processing device; and memory operatively coupled to the processing device, wherein the memory stores computer program instructions that, when executed, cause the processing device to: monitor activity of a liquid-cooled system; determine, based on the activity, that a component balance of a coolant of the liquid-cooled system should be modified; and add, to a cooling loop of the liquid-cooled system, a component of the coolant to modify the component balance of the coolant. This provides the advantage of allowing for the component balance of coolant to be adjusted over time, preventing performance degradation and component damage that may occur due to unaddressed changes in the component balance.

In some aspects, to determine that the component balance should be modified, the computer program instructions, when executed, cause the processing device to determine that one or more performance metrics of the liquid-cooled system fails to satisfy one or more conditions. This provides the advantage of using negative changes in performance metrics to trigger a rebalancing of the component balance.

In some aspects, to add the component, the computer program instructions, when executed, cause the processing device to incrementally add the component until the one or more performance metrics satisfy the one or more conditions. This provides the advantage of allowing for component rebalancing without specifically predicting the current component balance of the coolant, instead using the performance metrics to drive component rebalancing.

In some aspects, to determine that the component balance should be modified, the computer program instructions, when executed, cause the processing device to predict a current component balance. This provides the advantage of allowing for predicted changes in the component balance to trigger a rebalancing of the component balance.

In some aspects, predicting the current component balance is based on a configuration of the liquid-cooled system. This provides the advantage of more accurate predictions of current component balances that take into account the configuration of the liquid-cooled system.

In some aspects, to determine that the component balance should be modified, the computer program instructions, when executed, cause the processing device to measure a coolant level in a mixture reservoir of the liquid-cooled system. This provides the advantage of allowing for current levels of coolant in a mixture reservoir to trigger component rebalancing.

In some aspects, wherein the computer program instructions, when executed, further cause the processing device to determine a target component balance for the liquid cooled system, and adding the component is based on the target component balance. This provides the advantage of enabling component rebalancing to achieve a targeted component balance for the liquid-cooled system.

In some aspects, determining the target component balance is based on a configuration of the liquid-cooled system. This provides the advantage of more accurate target component balances that take into account the configuration of the liquid-cooled system.

In some aspects, to determine the target component balance, the computer program instructions, when executed, further cause the processing device to receive data indicating the target component balance. This provides the advantage of enabling remotely determined or calculated target component balances to be received by a liquid-cooled system.

In some aspects, computer program product for coolant mixture rebalancing for liquid-cooled systems includes a computer readable storage medium storing computer program instructions that, when executed: monitor activity of a liquid-cooled system; determine, based on the activity, that a component balance of a coolant of the liquid-cooled system should be modified; and add, to a cooling loop of the liquid-cooled system, a component of the coolant to modify the component balance of the coolant. This provides the advantage of allowing for the component balance of coolant to be adjusted over time, preventing performance degradation and component damage that may occur due to unaddressed changes in the component balance.

Liquid-cooled systems draw heat from components such as processors by transferring heat from these components to a coolant pumped through the system. Heat is then drawn from the heated coolant and dispersed so as to return the coolant to a cool state. In some of these systems, the coolant is a mixture of multiple components. When the system is initialized the components of the coolant are present in a particular ratio or balance. This balance may change over time as the system operates. For example, one of the components may seep through hoses of the cooling loop or evaporate, thereby changing the balance of the components of the coolant. This may affect the cooling ability of the coolant, which may in turn cause performance degradation or component damage.

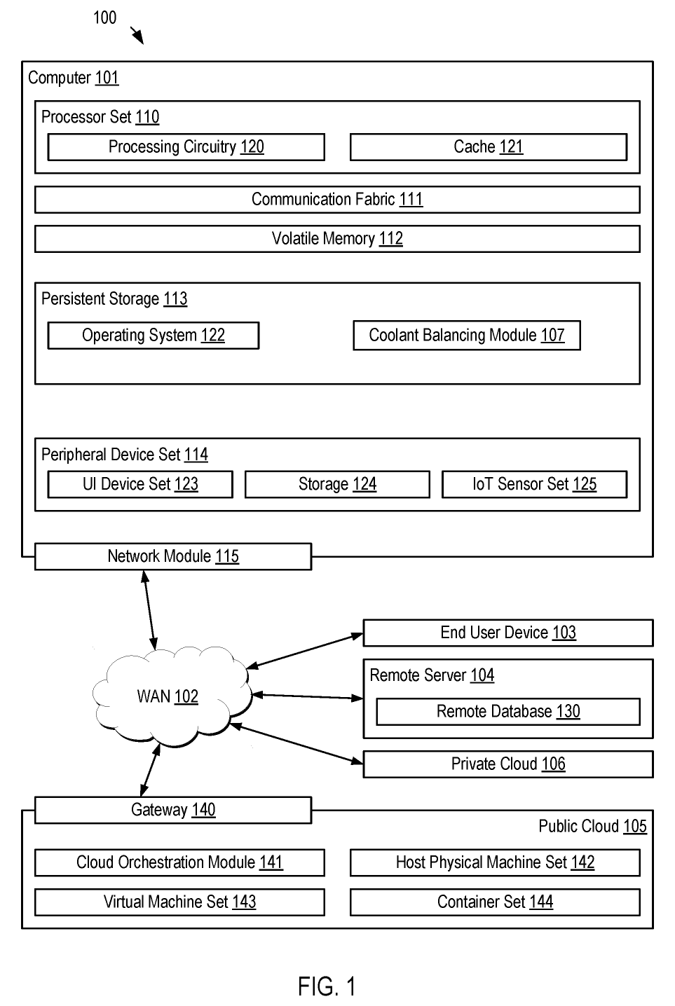

With reference now to FIG. 1, shown is an example computing environment according to aspects of the present disclosure. Computing environment 100 contains an example of an environment for the execution of at least some of the computer code involved in performing the various methods described herein, such as a cooling balancing module 107. In addition to the cooling balancing module 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in block 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

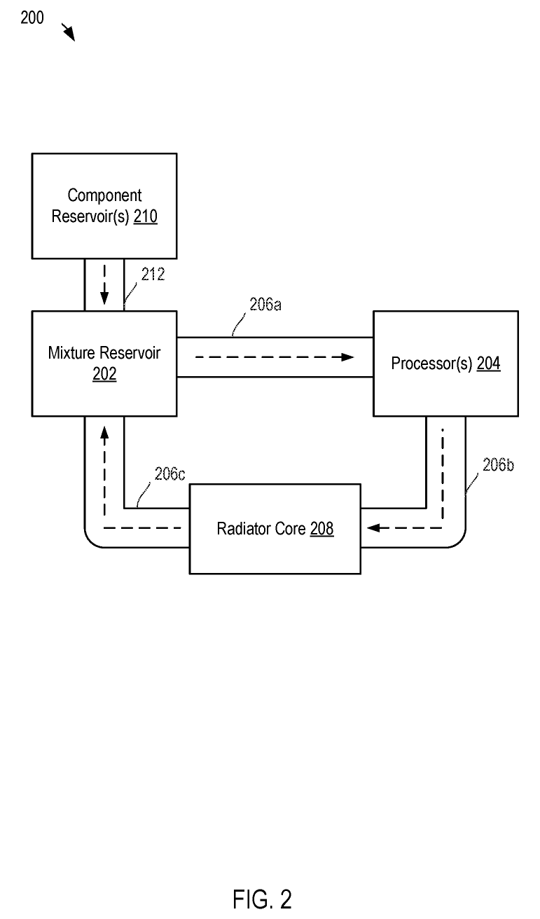

FIG. 2 sets forth a diagram of an example liquid-cooled system 200 in accordance with some embodiments of the present disclosure. The example liquid-cooled system 200 may include a variety of computing devices or systems as can be appreciated, including servers, desktop computers, mainframes, mobile computing devices, and the like. Readers will appreciate that the example liquid-cooled system 200 is merely illustrative and that other configurations are contemplated within the scope of the present disclosure. Moreover, readers will appreciate that various components of the liquid-cooled system 200 are omitted for clarity and conciseness.

The liquid-cooled system 200 includes a mixture reservoir 202. The mixture reservoir 202 is a container housing coolant for the liquid-cooled system 200. In some embodiments, the mixture reservoir 202 may include one or more level sensors describing a current level or amount of coolant in the mixture reservoir 202. The coolant may include a variety of multi-component coolants as can be appreciated. In other words, the coolant includes a mixture of multiple component chemicals or compounds. As an example, the coolant may include a mixture of propylene glycol and water. Coolant passes from the mixture reservoir 202 to one or more processors 204 via one or more hoses 206a. Although the liquid-cooled system 200 is described as using hoses, other fluid conveyances are also contemplated within the scope of the present disclosure such as pipes, tubes, and the like.

Heat is transferred from the processors 204 to the coolant (e.g., via cold plates), thereby cooling the processors 204. In some embodiments, The coolant could be used to cool other ASICs, motors, other electrical or mechanical components, or even airstreams to remove preheat within a system that contains front to rear cooling. This heated coolant passes to a radiator core 208 via another one or more hoses 206b. The radiator core 208 includes various components to draw heat from the heated coolant and disperse that heat. Such components may include, for example, radiators, fins, fans, and the like. The cooled coolant then passes back to the mixture reservoir 202 via one or more hoses 206c.

During operation of the liquid-cooled system 200, components of the coolant such as water may seep through the hoses 206a,b,c, thereby altering the proportion of the components in the coolant (e.g., the balance or distribution of components). For example, water seeping from a mixture of propylene glycol and water will cause the amount of propylene glycol to increase relative to the amount of water in the coolant. This may negatively impact performance of the liquid-cooled system 200. One or more components of the coolant may be added to the cooling loop of the liquid-cooled system 200 to modify the balance of components of the coolant. Particular approaches for adding coolant components to the cooling loop as well as particular conditions that may trigger adding these coolant components to the cooling loop will be described in further detail below.

Accordingly, the liquid-cooled system 200 also includes one or more component reservoirs 210. The one or more component reservoirs 210 separately house the individual components of the liquid-cooled system 200. In some embodiments, each component may be housed in a separate component reservoir 210. In some embodiments, multiple components may be housed in the same component reservoir 210 separated into individual chambers. In some embodiments, the one or more component reservoirs 210 may individually house each component of the coolant. For example, assuming a coolant that is a mixture of propylene glycol and water, the component reservoirs 210 may individually house propylene glycol and water in separate reservoirs or in separate chambers of the same reservoir. In some embodiments, the one or more component reservoirs 210 may individually house a subset (e.g., not all) components of the coolant. For example, a liquid-cooled system 200 may only include a component reservoir 210 for water as propylene glycol is less susceptible to seepage from the cooling loop.

To modify the balance of components in the coolant, some amount of one or more of the components of the coolant are added to the mixture reservoir 202 via one or more valves 212, thereby adding these components to the cooling loop of the liquid-cooled system 200. Although the approaches set forth herein describe adding coolant components to the mixture reservoir 202, readers will appreciate that, in some embodiments, these coolant components may be introduced into the cooling loop at other points, such as via injection into one or more of the hoses 206a,b,c.

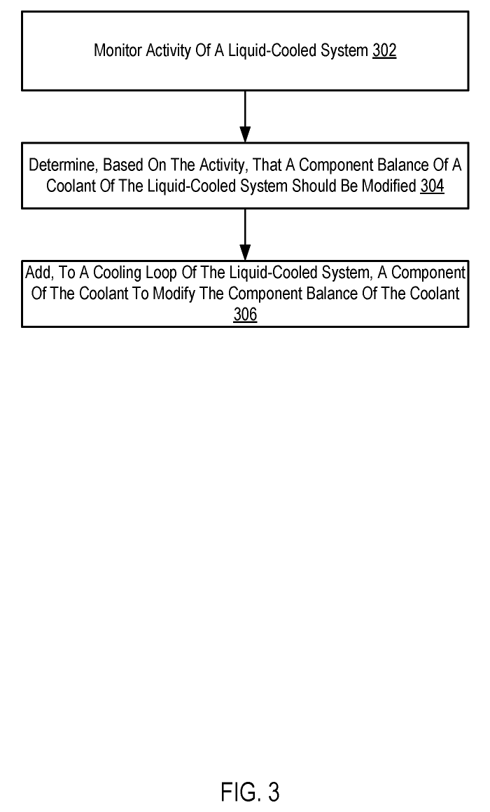

For further explanation, FIG. 3 sets forth a flowchart of an example method of coolant mixture rebalancing for liquid-cooled systems in accordance with some embodiments of the present disclosure. The method of FIG. 3 may be performed, for example, by a coolant balancing module 107 of FIG. 1. The method of FIG. 3 includes monitoring 302 activity of a liquid-cooled system 200. Monitoring 302 activity of a liquid-cooled system 200 may include monitoring various attributes related to the operation of the liquid-cooled system 200.

In some embodiments, such attributes may include an amount of time that the liquid-cooled system 200 has been running, an amount of time that the liquid-cooled system 200 has been running since the component balance of the coolant was last modified, and the like. In some embodiments, such attributes may include temperature readings for various components of the liquid-cooled system 200. In some embodiments, such attributes may include temperature or humidity measurements for an environment external to the liquid-cooled system 200. In some embodiments, such attributes may include various performance metrics of the liquid-cooled system 200. In some embodiments, such attributes may include data describing workloads or processing activity performed by the liquid-cooled system 200. In some embodiments, such attributes may include a measured level of coolant in a mixture reservoir 202 of the liquid-cooled system 200. In some embodiments, such attributes may include a flow rate of coolant in the liquid-cooled system 200, a total amount of coolant pushed through the cooling loop of the liquid-cooled system 200, and the like. In some embodiments, the attributes nay include a chemical breakdown of the coolant to extract the exact ratios of each of the components.

The method of FIG. 3 also includes determining 304, based on the activity, that a component balance of the liquid-cooled system 200 should be modified. Particular conditions and approaches for determining 304 the component balance of the liquid-cooled system 200 will be described in further detail below. For example, in some embodiments, this may include determining or predicting that the component balance of the liquid-cooled system 200 has fallen outside of some target range or tolerance relative to some target value. As another example, in some embodiments, this may include determining that performance metrics in the monitored 302 activity fail to satisfy some condition, such as failing to fall within some desired operational range, failing to fall within some tolerance relative to some target value for particular metrics, and the like.

The method of FIG. 3 also includes adding 306, to a cooling loop of the liquid-cooled system 200, a component of the coolant to modify the component balance of the coolant. In some embodiments, this may include adding an amount of a single component of the coolant or potentially multiple components of the coolant. Adding 306 the component of the coolant may include adding 306 the component from one or more component reservoirs 210 separately housing one or more components of the coolant. For example, in some embodiments, adding 306 the component may include actuating a valve 212 coupling a component reservoir 210 to a mixture reservoir 202.

Particularly, the amounts of each component added may be based on a predicted current component balance, a target component balance, and the like. For example, the amounts of each component may be added to adjust a predicted current component balance to equal or fall within some tolerance of a target component balance. The target component balance may include a predefined value or range, a dynamically calculated predefined value or range, and the like. In some embodiments, the amounts of each component added may be based on a measured level of coolant (e.g., in a mixture reservoir 202) and/or a tolerance for an amount of coolant in the coolant reservoir. The tolerance for the amount of coolant in the coolant reservoir may include minimum amount of coolant and/or a maximum amount of coolant. In some embodiments, a maximum amount of mixed coolant is allowed in the cooling loop (based on sensor readings). A separate drain reservoir may be used for removing some of the mixed coolant of the system to make room for the individual components. This would only be needed if the system added individual components in an incorrect amount or ratio to where there was too much mixed coolant in the loop.

As an example, assume that it is determined that the component balance of the coolant should be modified, with a predicted component balance of fifty-five percent water and forty-five percent propylene glycol. Further assume a target component balance of sixty percent water and forty percent propylene glycol. Accordingly, some amount of water should be added to the coolant mixture to modify the component balance to equal or fall within some tolerance of the target component balance. In some embodiments, the particular amount of water to be added may be based on a predicted amount of coolant in the system. For example, given a known amount of coolant when the system was initialized, the current amount of coolant in the system may be estimated based on the predicted component balance. In some embodiments, the particular amount of water to be added may be based on a measured amount of coolant in the mixture reservoir 202, amounts of coolant in hoses 206a,b,c (e.g., based on known hose measurements), and the predicted component balance. As another example, further assume that a predicted or measured amount of coolant in the mixture reservoir 202 falls below some tolerance. Here, amounts of both water and propylene glycol may be added to the mixture reservoir 202 so as to both modify the component balance and also raise the amount of coolant in the mixture reservoir 202 to within the tolerance.

The approaches set forth above provide for rebalancing components in a multi-component coolant mixture of a liquid-cooled system 200. This prevents performance degradation and/or component damage that may be caused by changes in the component balance of the coolant.

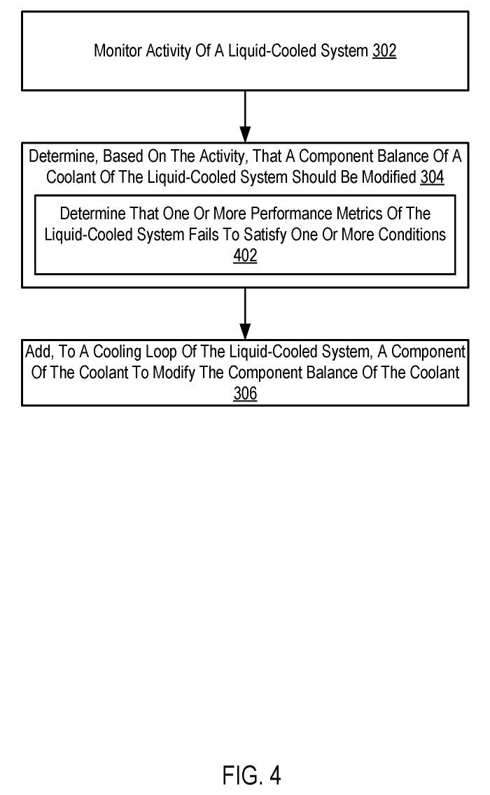

For further explanation, FIG. 4 sets forth a flowchart of an example method of coolant mixture rebalancing for liquid-cooled systems in accordance with some embodiments of the present disclosure. The method of FIG. 4 is similar to FIG. 3 in that the method of FIG. 4 also includes: monitoring 302 activity of a liquid-cooled system 200; determining 304, based on the activity, that a component balance of a coolant of the liquid-cooled system 200 should be modified; and adding 306, to a cooling loop of the liquid-cooled system 200, a component of the coolant to modify the component balance of the coolant.

The method of FIG. 4 differs from FIG. 3 in that determining 304, based on the activity, that a component balance of a coolant of the liquid-cooled system 200 should be modified includes determining 402 that one or more performance metrics of the liquid-cooled system 200 fails to satisfy one or more conditions. As is set forth above, the monitored 302 activity may include various performance metrics of the liquid-cooled system 200, such as times to complete certain tasks, latencies, processing rates, and the like. Where these performance metrics fail to satisfy some condition, this may indicate that the component balance of the coolant of the liquid-cooled system has changed over time so as to negatively affect performance. For example, the one or more performance metrics may fall below or exceed some threshold, may fall outside of some defined range, or may fail to satisfy other conditions as can be appreciated.

Accordingly, adding 306 the component of the coolant will be performed in response to these performance metrics failing to satisfy the one or more conditions. In some embodiments, determining 402 that the one or more performance metrics fail to satisfy the one or more conditions may cause a predicted component balance to be calculated, described in further detail below, so as to calculate how much of a given component to add 306 to the cooling loop of the liquid-cooled system.

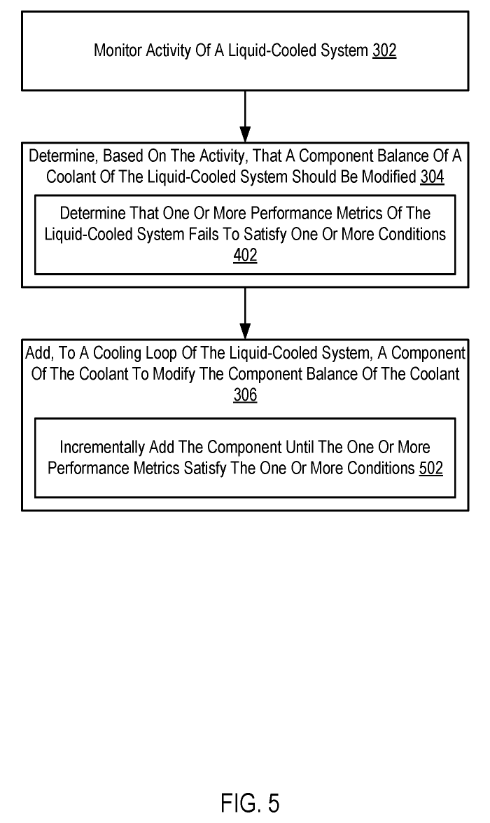

For further explanation, FIG. 5 sets forth a flowchart of an example method of coolant mixture rebalancing for liquid-cooled systems in accordance with some embodiments of the present disclosure. The method of FIG. 5 is similar to FIG. 4 in that the method of FIG. 5 also includes: monitoring 302 activity of a liquid-cooled system 200; determining 304, based on the activity, that a component balance of a coolant of the liquid-cooled system 200 should be modified, including: determining 402 that one or more performance metrics of the liquid-cooled system 200 fails to satisfy one or more conditions; and adding 306, to a cooling loop of the liquid-cooled system 200, a component of the coolant to modify the component balance of the coolant.

The method of FIG. 5 differs from FIG. 4 in that adding 306, to a cooling loop of the liquid-cooled system 200, a component of the coolant to modify the component balance of the coolant includes incrementally adding 502 the component until the one or more performance metrics satisfy the one or more conditions. In some embodiments, rather than calculating any predicted component balance to determine how much of a given component to introduce to the cooling loop, some amount of a component may be added. This amount may include a predefined amount or a dynamically calculated amount. For example, the amount may be dynamically calculated based on the one or more performance metrics, such as a degree to which the one or more performance metrics fall outside of some threshold or range corresponding to the one or more conditions that were not satisfied.

After adding this amount of the component, the performance metrics may be monitored for some amount of time to determine if they now satisfy the one or more conditions. If they do, no more of the component needs to be added to the cooling loop. If they do not, another amount of the component (e.g., predefined or dynamically calculated) is added to the cooling loop and the performance metrics monitored. This process of adding the component to the cooling loop and monitoring the performance metrics repeats until the one or more performance metrics satisfy the one or more conditions.

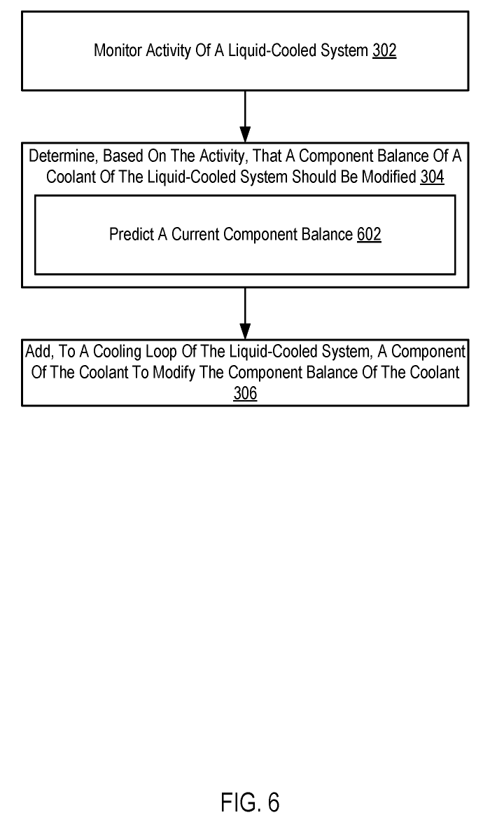

For further explanation, FIG. 6 sets forth a flowchart of an example method of coolant mixture rebalancing for liquid-cooled systems in accordance with some embodiments of the present disclosure. The method of FIG. 6 is similar to FIG. 3 in that the method of FIG. 6 also includes: monitoring 302 activity of a liquid-cooled system 200; determining 304, based on the activity, that a component balance of a coolant of the liquid-cooled system 200 should be modified; and adding 306, to a cooling loop of the liquid-cooled system 200, a component of the coolant to modify the component balance of the coolant.

The method of FIG. 6 differs from FIG. 3 in that determining 304, based on the activity, that a component balance of a coolant of the liquid-cooled system 200 should be modified includes predicting 602 a current component balance. Predicting 602 the current component balance includes calculating or otherwise estimating a balance of components in the coolant of the liquid-cooled system 200. In some embodiments, predicting 602 the current component balance may be based on various attributes of the monitored 302 activity described above. In some embodiments, predicting 602 the current component balance may be based on attributes of a configuration of the liquid-cooled system 200. For example, such attributes may include a length of hoses used in the liquid-cooled system 200, a diameter of those hoses, a surface area of those hoses, or other attributes that may affect component seepage or evaporation during operation of the liquid-cooled system. In some embodiments, predicting the current component balance may be based on monitored system activity, workload activity, and the like.

In some embodiments, predicting 602 the current component balance may include providing one or more attributes of the monitored 302 activity and/or the configuration of the liquid-cooled system 200 into a function or algorithm used to calculate an estimated current component balance. For example, a current component balance may be estimated as a function of system uptime, system activity, environmental conditions, hose sizes, coolant flow rates, and the like.

In some embodiments, predicting 602 the current component balance may include providing attributes of the monitored 302 activity and/or the configuration of the liquid-cooled system 200 as input to a trained model configured to estimate a component balance of the liquid-cooled system 200. For example, such a trained model may be trained using training data describing, for a given liquid-cooled system, performance metrics, coolant levels, measured component balances, environmental conditions, hose sizes, flow rates, and/or other data as can be appreciated.

Given the predicted current component balance, it may be determined 304 that the component balance of the coolant of the liquid-cooled system 200 should be modified where the predicted current component balance fails to satisfy some condition. For example, it may be determined 304 that the component balance of the coolant of the liquid-cooled system 200 should be modified where the predicted current component balance fails to equal some target component balance, fails to fall within some range, fails to fall within a tolerance relative to a target component balance, and the like.

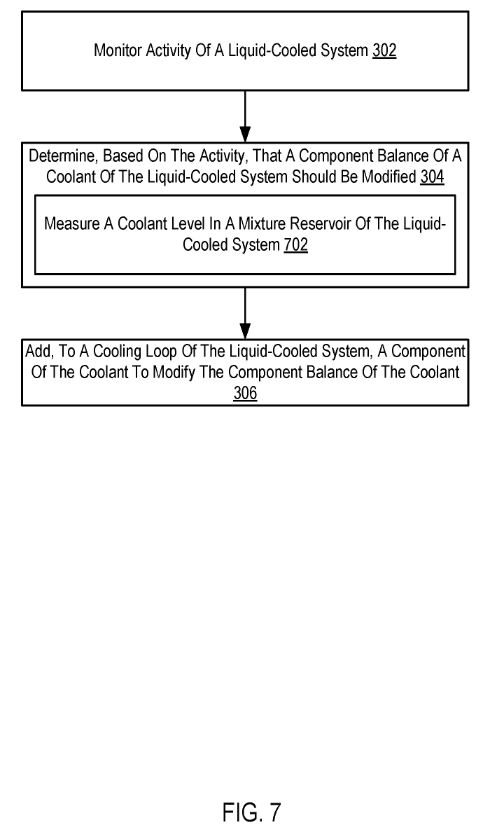

For further explanation, FIG. 7 sets forth a flowchart of an example method of coolant mixture rebalancing for liquid-cooled systems in accordance with some embodiments of the present disclosure. The method of FIG. 7 is similar to FIG. 3 in that the method of FIG. 7 also includes: monitoring 302 activity of a liquid-cooled system 200; determining 304, based on the activity, that a component balance of a coolant of the liquid-cooled system 200 should be modified; and adding 306, to a cooling loop of the liquid-cooled system 200, a component of the coolant to modify the component balance of the coolant.

The method of FIG. 7 differs from FIG. 3 in that determining 304, based on the activity, that a component balance of a coolant of the liquid-cooled system 200 should be modified includes measuring 702 a coolant level in a mixture reservoir 202 of the liquid-cooled system 200. As is set forth above, in some embodiments, a mixture reservoir 202 may include one or more sensors to measure a level of coolant in the mixture reservoir 202. In some embodiments, the coolant level in the mixture reservoir 202 may be used as a factor in estimating (e.g., using a formula, algorithm, or trained model) a current component balance as described above. In some embodiments, the coolant level may be used as criteria for adding components to the cooling loop without specifically estimating a current component balance. For example, in some embodiments, where the coolant level falls below some threshold or outside of some tolerance, an amount of some component may be added to the cooling loop so as to raise the overall coolant level to above the threshold or to fall within some tolerance.

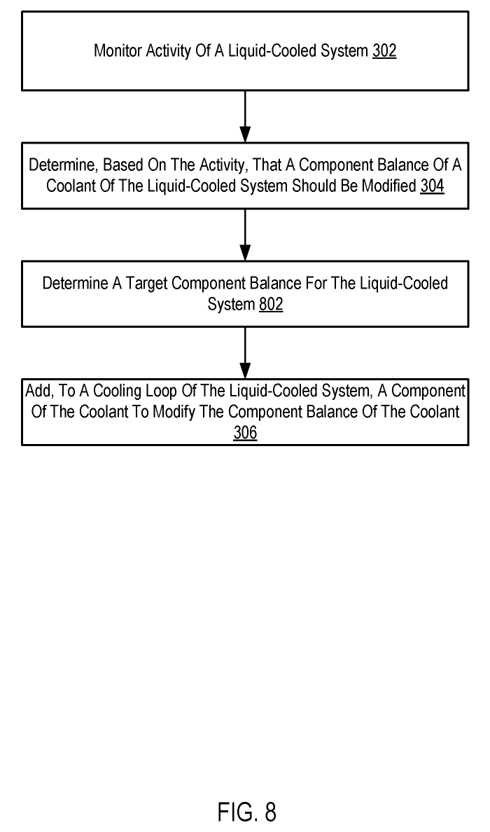

For further explanation, FIG. 8 sets forth a flowchart of an example method of coolant mixture rebalancing for liquid-cooled systems in accordance with some embodiments of the present disclosure. The method of FIG. 8 is similar to FIG. 3 in that the method of FIG. 8 also includes: monitoring 302 activity of a liquid-cooled system 200; determining 304, based on the activity, that a component balance of a coolant of the liquid-cooled system 200 should be modified; and adding 306, to a cooling loop of the liquid-cooled system 200, a component of the coolant to modify the component balance of the coolant.

The method of FIG. 8 differs from FIG. 3 in that the method of FIG. 8 also includes determining 802 a target component balance for the liquid-cooled system 200. In some embodiments, the target component balance may include a range of component balances into which a component balance may fall. In some embodiments, the target component balance may include a particular component balance value. In some embodiments, the target component balance may be predefined. For example, the target component balance may include some configurable or default value or range. In some embodiments, as will be described in further detail below, the target component balance may be indicated in data received from some remotely disposed device or service.

In some embodiments, the target component balance may be dynamically calculated or determined. For example, the target component balance may be calculated as a function of attributes of the configuration of the liquid-cooled system 200, monitored 302 attributes such as environmental conditions, system workloads, coolant flow rates, and the like. In some embodiments, the target component balance may be calculated using a function or algorithm. In some embodiments, the target component balance may be determined by applying one or more rules to these attributes. In some embodiments, these attributes may be provided as input to a trained model configured to calculate a target component balance.

After determining 802 the target component balance, the component may be added 306 based on this target component balance. For example, in some embodiments, the component may be added 306 so as to adjust a predicted current component balance to equal the target component balance, to fall within some range defined by the target component balance, to fall within some tolerance of the target component balance, and the like.

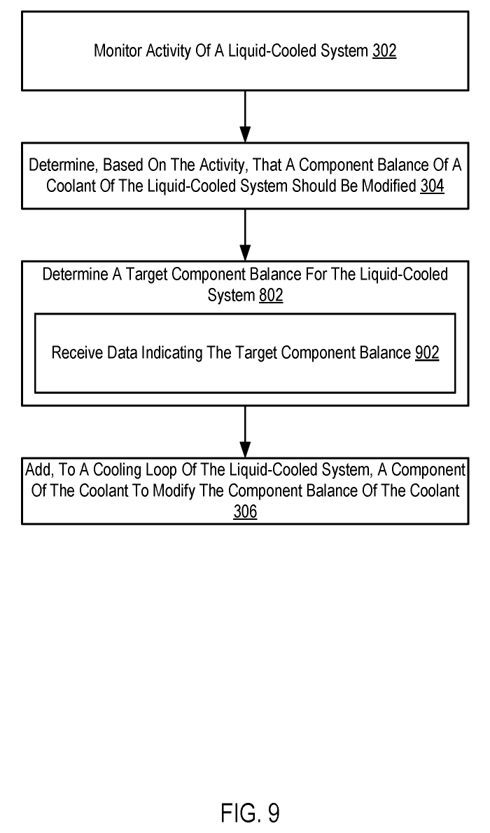

For further explanation, FIG. 9 sets forth a flowchart of an example method of coolant mixture rebalancing for liquid-cooled systems in accordance with some embodiments of the present disclosure. The method of FIG. 9 is similar to FIG. 8 in that the method of FIG. 9 also includes: monitoring 302 activity of a liquid-cooled system 200; determining 304, based on the activity, that a component balance of a coolant of the liquid-cooled system 200 should be modified; determining 802 a target component balance for the liquid-cooled system 200; and adding 306, to a cooling loop of the liquid-cooled system 200, a component of the coolant to modify the component balance of the coolant.

The method of FIG. 9 differs from FIG. 8 in that determining 802 a target component balance for the liquid-cooled system 200 also includes receiving 902 data indicating the target component balance. As an example, in some embodiments, the liquid-cooled system 200 may provide, to a remotely disposed device or service, data indicating various attributes (e.g., configuration attributes, environmental conditions, performance metrics, and the like) and receive, in response, data indicating the target component balance. In some embodiments, the remotely disposed device or service may calculate the target component balance using similar approaches as are set forth above.

In some embodiments, the target component balance may be based on a clustering of data describing a plurality of other liquid-cooled systems. Such data may also describe the liquid-cooled system 200. A clustering may be performed based on data aggregated from these liquid-cooled systems that indicate the various attributes set forth above. For example, in some embodiments, these liquid-cooled systems may be configured to provide this data periodically, such as at a predefined interval or in response to other conditions. Each cluster may have a corresponding assigned or calculated component balance. Accordingly, the component balance for a cluster corresponding to the liquid-cooled system 200 may be used to determine the target component balance for the liquid-cooled system 200.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
monitoring activity of a liquid-cooled system;
determining, based on the activity, that a component balance of a coolant of the liquid-cooled system should be modified; and
adding, to a cooling loop of the liquid-cooled system, a component of the coolant to modify the component balance of the coolant.

2. The method of claim 1, wherein determining that the component balance should be modified comprises determining that one or more performance metrics of the liquid-cooled system fails to satisfy one or more conditions.

3. The method of claim 2, wherein adding the component comprises incrementally adding the component until the one or more performance metrics satisfy the one or more conditions.

4. The method of claim 1, wherein determining that the component balance should be modified comprises predicting a current component balance.

5. The method of claim 4, wherein predicting the current component balance is based on a configuration of the liquid-cooled system.

6. The method of claim 1, wherein determining that the component balance should be modified comprises measuring a coolant level in a mixture reservoir of the liquid-cooled system.

7. The method of claim 1, further comprising determining a target component balance for the liquid cooled system, wherein adding the component is based on the target component balance.

8. The method of claim 7, wherein determining the target component balance is based on a configuration of the liquid-cooled system.

9. The method of claim 8, wherein determining the target component balance comprises receiving data indicating the target component balance.

10. The method of claim 9, wherein the data is based on a clustering of data describing a plurality of other liquid-cooled systems.

11. An apparatus comprising:
a processing device; and
memory operatively coupled to the processing device, wherein the memory stores computer program instructions that, when executed, cause the processing device to:
monitor activity of a liquid-cooled system;
determine, based on the activity, that a component balance of a coolant of the liquid-cooled system should be modified; and
add, to a cooling loop of the liquid-cooled system, a component of the coolant to modify the component balance of the coolant.

12. The apparatus of claim 11, wherein, to determine that the component balance should be modified, the computer program instructions, when executed, cause the processing device to determine that one or more performance metrics of the liquid-cooled system fails to satisfy one or more conditions.

13. The apparatus of claim 12, wherein, to add the component, the computer program instructions, when executed, cause the processing device to incrementally add the component until the one or more performance metrics satisfy the one or more conditions.

14. The apparatus of claim 11, wherein, to determine that the component balance should be modified, the computer program instructions, when executed, cause the processing device to predict a current component balance.

15. The apparatus of claim 14, wherein predicting the current component balance is based on a configuration of the liquid-cooled system.

16. The apparatus of claim 11, wherein, to determine that the component balance should be modified, the computer program instructions, when executed, cause the processing device to measure a coolant level in a mixture reservoir of the liquid-cooled system.

17. The apparatus of claim 11, wherein the computer program instructions, when executed, further cause the processing device to determine a target component balance for the liquid cooled system, wherein adding the component is based on the target component balance.

18. The apparatus of claim 17, wherein determining the target component balance is based on a configuration of the liquid-cooled system.

19. The apparatus of claim 18, wherein, to determine the target component balance, the computer program instructions, when executed, further cause the processing device to receive data indicating the target component balance.

20. A computer program product comprising a computer readable storage medium, wherein the computer readable storage medium comprises computer program instructions that, when executed:
monitor activity of a liquid-cooled system;
determine, based on the activity, that a component balance of a coolant of the liquid-cooled system should be modified; and
add, to a cooling loop of the liquid-cooled system, a component of the coolant to modify the component balance of the coolant.
